(19) United States
(12) Patent Application Publication
(10) Pub. No.: US 2022/0364902 A1
(43) Pub. Date: Nov. 17, 2022

(54) CALIBRATING FLUID FLOW MEASUREMENTS IN FLUID FLOW SYSTEMS

(71) Applicant: StormSensor Inc., Seattle, WA (US)

(72) Inventors: Erin Rothman, Seattle, WA (US); Emily Mistick, Seattle, WA (US); Suzie Housley, Seattle, WA (US); Marie Jordan, Seattle, WA (US)

(21) Appl. No.: 17/661,992

(22) Filed: May 4, 2022

Related U.S. Application Data
(60) Provisional application No. 63/185,787, filed on May 7, 2021.

(51) Int. Cl. G01F 25/10

(52) U.S. Cl. CPC G01F 25/10

(57) ABSTRACT

The invention is directed towards calibrating fluid flow measurements. A method includes receiving fluid velocity and depth data from sensors placed in the flow channel. Once calibrated based on direct measurements from the flow channel, a depth or velocity of the fluid in the flow path is approximated based on a fluid-flow model, a set of flow path parameters, and the magnitude of the velocity or depth measured. These values can be determined for multiple flow regimes. The set of flow path parameters characterizes one or more properties of the flow path. An effective area of the flow path is calculated based on the depth of the fluid flowing in the flow path and the set of flow path parameters. A flow rate of the fluid flowing in the flow path is determined based on the magnitude of the velocity of the fluid flowing in the flow path. An indication of the flow rate of the fluid is provided to a user.

### CROSS-REFERENCE TO RELATED APPLICATIONS

This application is claims priority to U.S. Provisional Patent Application No. 63/185,787, entitled WORKFLOW FOR CALIBRATING WATER FLOW MEASUREMENTS, filed May 7, 2021, the contents of which is hereby incorporated by reference in its entirety.

### BACKGROUND

Stormwater drainage systems (e.g. storm drains and sewers) are employed to redirect excess rain and ground water from impervious surfaces through a network of flow paths and/or flow channels. Such flow paths and/or channels are typically constructed via cavities, flow paths, or flow channels within pipes, tunnels, gutters, and the like. Water flow through such a pipe may be determined by several factors, such as the roughness of the pipe's interior surface, a height of the water in the pipe, and a slope of a hydraulic grade (e.g., a slope of the pipe with respect to gravitational field), and others. If the water level in the drainage system is raised beyond a system threshold or capacity, a sufficient backpressure in the system may force water out of the system's outputs, resulting in an “overflow” event. Exceeding system capacity can cause overflow events to occur. Stormwater drainage system operators typically use Manning's equation to estimate water flow through such pipes. Such estimates can be used to anticipate overflow events and plan for capacity and monitoring improvements to the system. However, conventional application of Manning's equation may generate inaccurate results for estimating water flow within cavities of storm and wastewater systems.

### SUMMARY

Various aspects of the technology described herein are generally directed towards one or more of methods, system, and/or non-transitory computer readable storage media. Embodiments of the present invention are directed toward systems and methods for calibrating fluid flow measurements. In one non-limiting method embodiment, a method includes receiving fluid velocity data. The fluid velocity data encodes a magnitude of a velocity for a fluid that is flowing in a flow path. A depth of the fluid in the flow path may be approximated based on a fluid-flow model, a set of flow path parameters, and the magnitude of the velocity. The set of flow path parameters may characterize one or more properties of the flow path. An effective area of the flow path may be calculated based on the depth of the fluid flowing in the flow path and the set of flow path parameters. A flow rate of the fluid flowing in the flow path may be determined based on the partially filled cross-sectional area and the magnitude of the velocity of the fluid within the flow path.

In at least one embodiment, the fluid-flow model may be a version of a Manning's equation (ME). The method may further include determining values for a set of parameters based on the fluid velocity data. The values for the set parameters may be associated with the version of the ME. The depth of the fluid in the flow path may be iteratively approximated based on the determined values for the set of parameters. The set parameters may include a first parameter that is added to a roughness coefficient of the version of the ME. The set of parameters may additionally include a second parameter that acts as an exponent in the version of the ME.

The method may further include providing an indication of the flow rate of the fluid to a user. The fluid velocity data may have been acquired by and transmitted from, via a communication network or directly, a sensor installed within the flow path. The set of flow path parameters may include at least a roughness coefficient that characterizes a roughness of the flow path, a dimension of the flow path, and a slope of a hydraulic grade of the flow path. The method may further include determining a wetted perimeter based on a dimensions of the flow path and the depth of the fluid. A hydraulic radius of the flow path may be determined based on the effective area of the flow path and the wetted perimeter of the flow path. The flow rate of the fluid may be determined based on the hydraulic radius of the flow path.

### BRIEF DESCRIPTION OF THE DRAWINGS

The technology described herein is described in detail below with reference to the attached drawing figures, wherein:

FIG. 1 includes a block diagram showing a fluid flow system, in which some embodiments of the present disclosure may be employed;

FIG. 2A provides a flow diagram is that illustrates a method for determining a volumetric flow rate of fluid based on a measurement of the fluid's velocity in a fluid flow system that is consistent with the various embodiments;

FIG. 2B provides a flow diagram that illustrates a method for determining a volumetric flow rate of fluid based on a measurement of the fluid's depth in a fluid flow system that is consistent with the various embodiments;

FIG. 2C provides a flow diagram that illustrates a method for determining values for an additive parameter and a magnitude parameter, as a function of fluid velocity, based on a measurement of the fluid's velocity and a measurement of the fluid's depth in a fluid flow system that is consistent with the various embodiments; and

FIG. 3 is a block diagram of an exemplary computing environment suitable for use in implementing aspects of the technology described herein.

### DETAILED DESCRIPTION

### Overview of Technical Problems, Technical Solutions, and Technological Improvements

Manning's equation (or formula) is an empirical formula empirical for estimating the average velocity of a liquid flowing in a flow path (e.g., pipe, channel, conduit, trench, and/or cavity) that does not completely enclose the liquid, i.e., the flow path has one or more “inputs” and one or more “outputs.” The flow of the fluid may be primarily driven by a gravitational field. That is, the flow path may be positioned at an incline with respect to a gravitational field, where the input of the flow path has a higher gravitational potential than the output of the flow path. The conventional expression of Manning's equation is:

$$V = \frac{k}{n} \cdot {R}_{h}^{\frac{2}{3}} \cdot {S}^{{-}_{2}^{1}} .$$

where V is the cross-sectional average velocity of the fluid (e.g., as expressed in units of length per unit time), n is the Gauckler-Manning coefficient, Rₕ is the hydraulic radius of the flow path, S is the hydraulic grade of the flow path (e.g., related to the incline of the flow path with respect to the gravitational field), and k is a conversion factor between unit systems (e.g., international system of units (SI) and English units). The Gauckler-Manning coefficient is an empirical value derived from experimental observation for a flow path, and is related to the surface roughness and sinuosity of the flow path. The Gauckler-Manning coefficient for a flow path may be analogized to the “resistance” of the flow path for transmitting the flow of water, similar to the electrical resistance of an electrical current-carrying conductive wire. The hydraulic radius is dependent on the depth of the fluid in the flow path, as compared to the total cross-sectional area (e.g., A_{T} as measured in units of square-length) of the flow path (e.g., the total cross-sectional area of the floe path that is orthogonal to the direction of the fluid's velocity).

When managing drainage systems and other systems of dynamic fluid-flow, it is often useful o characterize the system in terms of volumetric flow rate (e.g., Q) rather than fluid velocity (e.g., V) The volumetric flow rate indicates the volume of fluid that flows out of the flow path's output (e.g., the volume of water that is discharged) per unit time, and may be indicated in units of cubic-length per unit of time). Volumetric flow rate and velocity are related by the discharge formula:

Q=V·A_{eff}

where A_{eff} is the “effective” cross-sectional area of the fluid flow. The effective cross-sectional area is the cross-sectional area of the actual cross-sectional area of the flowing fluid, as compared to the total cross-sectional area of the flow path. When the “height” or “depth” of the flowing fluid is equivalent to the “height” of “depth” of the flow path, then A_{eff}=Aₜ. In other conditions (e.g., when the depth of the flowing fluid is less than the depth of the flow path, then A_{eff}<A_{T}.

The embodiments provide improvements in the application of Manning's equation (ME), over conventional applications of ME. More specifically, the embodiments introduce a set of enhanced parameters that improve the accuracy of applications of ME to drainage systems, as well as other systems of dynamic fluid flow. The set of enhanced parameters may include at least an additive parameter and a magnitude parameter that can be applied to the conventional formulation of ME. Furthermore, the embodiments provide methods and systems that enable an accurate estimation and/or determination of the fluid depth when the velocity of the fluid (or volumetric flow rate) may be measured via one or more sensors. The embodiments also provide methods and systems that enable an accurate estimation and/or determination of the fluid velocity (or volumetric flow rate) when the depth of the fluid may be measured via one or more sensors. Because such embodiments employ the enhanced applications of ME, the estimations for the fluid velocity and the fluid depth provide greater accuracy than conventional methods of determining fluid velocity and/or fluid depth.

### Systems for Calibrating Fluid Flow Measurements

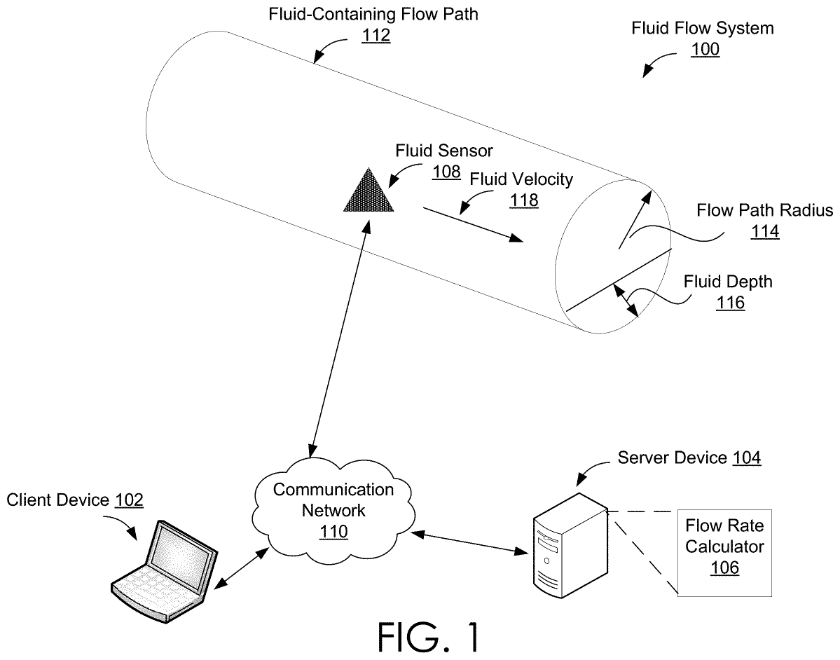

Aspects of the technical solution can be described by way of examples and with reference to FIG. 1 and additional illustrations below. FIG. 1 includes a block diagram showing a fluid flow system 100, in which some embodiments of the present disclosure may be employed. It should be understood that this and other arrangements described herein are set forth only as examples. Other arrangements and elements (e.g., machines, interfaces, functions, orders, and groupings of functions) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by an entity may be carried out by hardware, firmware, and/or software. For instance, some functions may be carried out by a processor executing instructions stored in memory.

Fluid flow system 100 includes a fluid-containing flow path 112. The flow path may be positioned at an incline, with respect to a gravitational field, which drives the flow of the fluid within the flow path 112. The direction of the fluid flow is indicated by the fluid velocity arrow 118, pointing down the incline of the flow path 112. In the non-limiting embodiment of FIG. 1, the flow path 112 is a pipe that includes an internal cavity with a circular cross-section. Note that the embodiments are not so limited, and the cross-section of the flow path may be any shape: elliptical, square, rectangular, square, triangular, or any other regular shape. In at least one embodiment, the cross-section of the flow path 112 may be an irregular shape. Although the below discussion is directed towards a circular cross-section, the embodiments may be extended to include other cross-sectional shapes.

The circular cross-section of the flow path is characterized by a flow path radius 114, which may be indicated as r in the following discussion. The fluid flowing through flow path 112 may be characterized with a fluid depth (or height) 116, which may be indicated as d in the following discussion. Note that d≤2·r. Data and/or information that characterize various aspects of the flow path 112 may be referred to as a set of flow path parameters. Various flow path parameters may include, but are not limited to flow path radius 114, the total cross-sectional area of the flow path 112, the perimeter and/or shape of the flow path 112, the Gauckler-Manning coefficient for the flow path (e.g., n in the ME, which indicates a roughness of the flow path), the slope of the hydraulic grade of the flow path (e.g., S in the ME), and the like. The Gauckler-Manning coefficient may be referred to as a roughness coefficient and/or a roughness parameter.

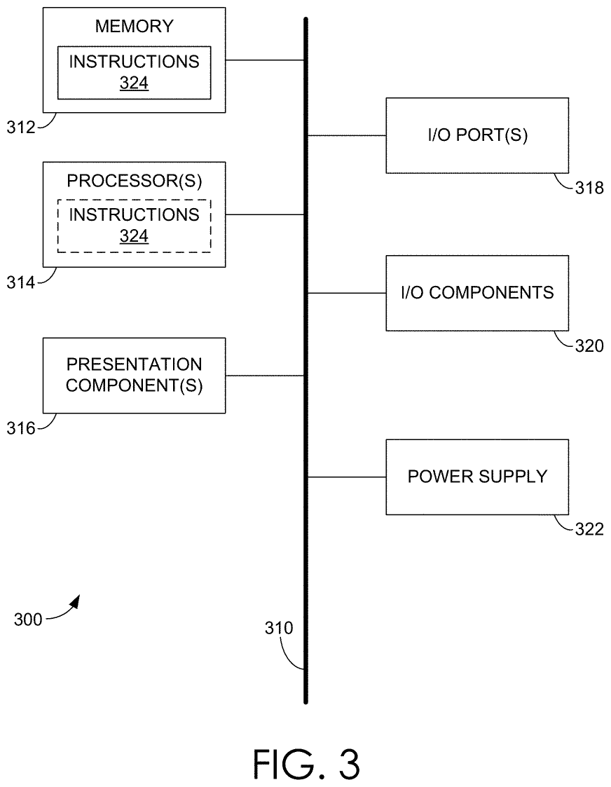

Fluid flow system 100 may additionally include at least one of a client computing device 102 and/or a server device 104. Various embodiments of computing devices are discussed in conjunction with at least computing device 300 of FIG. 3. However, briefly here, at least one of the client computing device 102 and/or the server computing device 104 may implement a flow rate calculator 106. The flow rate calculator 106 is generally responsible for implementing the various embodiments of the enhanced application of Manning's equations (ME), including estimating the fluid velocity, the volumetric flow rate, and/or the depth of the fluid within the flow path 112. Fluid flow system 100 may additionally include a communication network 110 that communicatively couples the client device 102 and the server device 104.

The fluid flow system 100 may additionally include a fluid sensor 108, embedded within the fluid flow path 112. Various embodiments of fluid sensors are discussed in conjunction with U.S. Pat. No. 10,292,025, entitled “Sensor Devices and Networks Acquiring Stormwater Data,” issued on May 4, 2019, the contents of which are herein incorporated in their entirety. U.S. Pat. No. 10,292,025 may be referred to throughout at the '025 patent. However, briefly here, fluid sensor 108 may be able to measure at least one of the fluid depth 116 or the magnitude of the fluid velocity 118 of the fluid flowing in the flow path 112. In some embodiments, fluid sensor 108 may be enabled to measure both the fluid depth 116 or the magnitude of the fluid velocity 118 of the fluid flowing in the flow path 112. The measurements of the fluid sensor 118 may be encoded in fluid sensor data generated and/or acquired by the fluid sensor 108. Fluid sensor data that encodes the magnitude of the fluid velocity 118 may be referred to as fluid velocity data. Fluid sensor data that encodes the depth 116 of the fluid velocity may be referred to as fluid depth data. Fluid sensor 108 may include a transmitter device, such that fluid sensor 108 is communicatively coupled, via communication network 110, with at least one of client computing device 102 and/or server computing device 104. Accordingly, flow rate calculator may have access to, and/or receive, fluid sensor data, including at least one of the fluid velocity data and/or the fluid depth data.

As noted above, the ME may take on the form of:

$$V = \frac{k}{n} \cdot {R}_{h}^{\frac{2}{3}} \cdot {S}^{\frac{1}{2}} ,$$

where V is the cross-sectional average velocity of the fluid (e.g., as expressed in units of length per unit time), n is the Gauckler-Manning coefficient, Rₕ is the hydraulic radius of the flow path, S is the hydraulic grade of the flow path (e.g., related to the incline of the flow path with respect to the gravitational field), and k is a conversion factor between unit systems (e.g., international system of units (SI) and English units). This version of the ME may be referred to throughout as a conventional (or first) version of the ME. The Gauckler-Manning coefficient is an empirical value derived from experimental observation for a flow path, and is related to the surface roughness and sinuosity of the flow path. The Gauckler-Manning coefficient for a flow path may be analogized to the “resistance” of the flow path for transmitting the flow of water, similar to the electrical resistance of an electrical current-carrying conductive wire. The hydraulic radius is dependent on the depth 116 of the fluid in the flow path, as compared to the total cross-sectional area (e.g., A_{T} as measured in units of square-length) of the flow path (e.g., the total cross-sectional area of the flow path that is orthogonal to the direction of the fluid's velocity). Note that when the cross-section of the flow path 112 is circular, then A_{T}=2πr², where r is the flow path radius 114.

When managing drainage systems and other systems of dynamic fluid-flow, it is often useful to characterize the system in terms of volumetric flow rate (e.g., Q) rather than fluid velocity (e.g., V). The volumetric flow rate indicates the volume of fluid that flows out of the flow path's output (e.g., the volume of water that is discharged) per unit time, and may indicated in units of cubic-length per unit of time). Volumetric flow rate and velocity are related by the discharge formula:

Q=V·A_{eff}

where A_{eff} is the “effective” cross-sectional area of the fluid flow. The effective cross-sectional area is the cross-sectional area of the actual cross-sectional area of the flowing fluid, as compared to the total cross-sectional area of the flow path (e.g., A_{T}). When the fluid depth 116 is such that 2·r=d, then A_{eff}=Aₜ. In other conditions (e.g., when the depth 116 of the flowing fluid is less than twice the radius 114 of the flow path, then A_{eff}<A_{T}).

In various embodiments, the hydraulic radius may be quantified as:

$${R}_{h} = \frac{{A}_{eff}}{{P}_{w e t}} ,$$

where P_{wet} is the “wetted” perimeter (e.g., the length of the portion of the internal cavity of flow path 112 that is “wet” from the flowing fluid). To employ similar terminology to the wetted perimeter, the effective area may be referred to as the “wetted” area (e.g., A_{wet}≡A_{eff}). Both the effective area and the wetted perimeter depend explicitly on the fluid depth 116 and the flow path radius 114. In embodiments where the cross-section of the flow path 112 is a circular cross section, then

$${A}_{eff} = \frac{1}{2} \cdot {r}^{2} \cdot ( θ - sin θ ) and$$

$${P}_{w e t} = θ \cdot r , where$$

$$θ = 2 \cdot ArcCos ( \frac{r - d}{r} ) .$$

Note that these expressions for the hydraulic radius, the effective area, and the wetted perimeter are non-limiting. Other embodiments may employ different calculations for the hydraulic radius, the effective area, and the wetted perimeter.

In at least one embodiment, the standard ME equation may be modified to result in an enhanced ME that includes an additive parameter (e.g. ξ), and a magnitude parameter (e.g., λ). The additive parameter and the magnitude parameter may be collectively referred to as a set of enhanced parameters for the ME. The enhanced form of the ME may be expressed as:

$$V = {( ( \frac{k}{n + ξ} ) \cdot {R}_{h}^{\frac{2}{3}} \cdot {S}^{\frac{1}{2}} )}^{λ} .$$

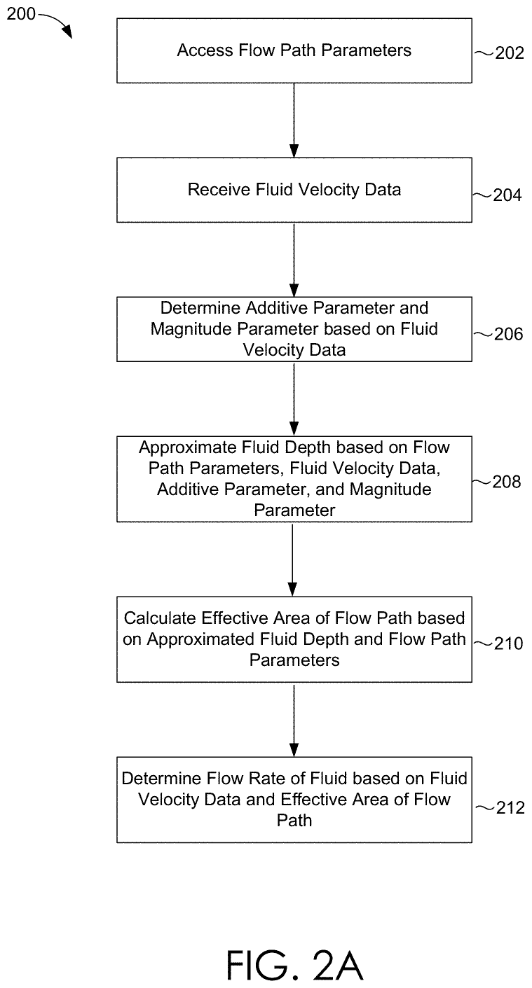

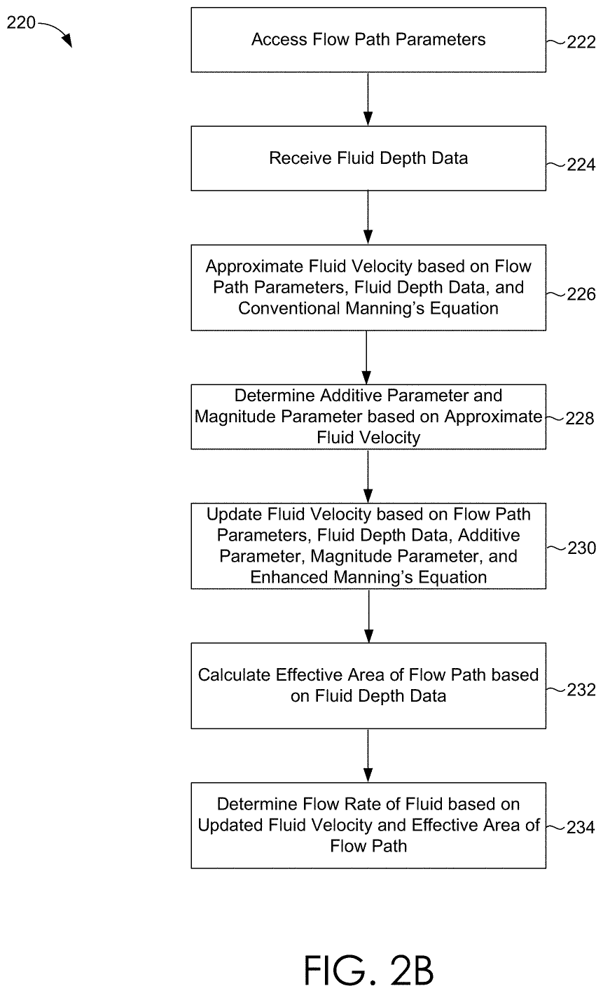

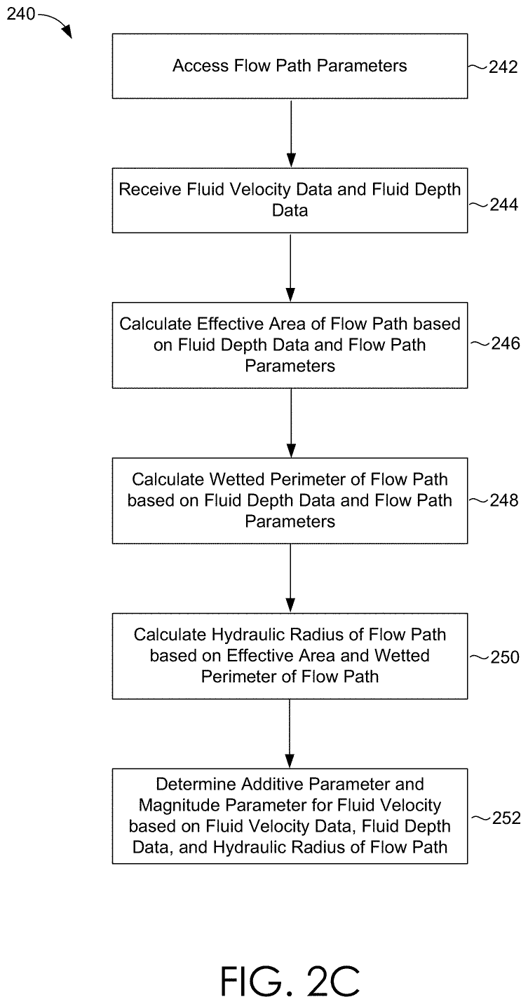

This version the ME may be referred to throughout as an enhanced (or second) version of the ME. With proper selections of values for the set of enhanced parameters, the enhanced form of ME may result in significantly improved estimates for the magnitude of the fluid flow velocity 118. The values for the set of enhanced parameters may be determined via empirical observations. One non-limiting embodiment for empirically determining the values for the set of enhanced parameters is discussed in conjunction with at least FIG. 2C. Note that the fluid velocity is dependent upon the fluid depth 116 because the hydraulic radius depends on both the effective area and the wetted perimeter, both of which depend directly of the fluid depth 116 (e.g., d).

In some embodiments, a sensor (e.g., fluid sensor 108) may be enabled to acquire sensor data that encodes the magnitude of the fluid velocity 118. The velocity encoding sensor data may be provided to the flow rate calculator 106 via the communication network 110. Accordingly, either the first or second version of the ME and the measurement of the magnitude of velocity may be employed to estimate, calculate, and/or predict the fluid depth 116. For instance, the measurement of V may be substituted in one of the versions of the ME, and d may be isolated algebraically, e.g., the ME equation may be solved ford. In various embodiments, one or more numerical methods may be employed to determine the fluid depth 116. For example, for circular cross-sections, 0≤d≤2·r. The value of d may be allowed to vary within this range, at whatever granularity is sufficient given fluid flow system 100 and a desired computational time. The varying values may be substituted into either version of the ME, until the calculated value of the fluid velocity (e.g., V) is consistent with the measured value. Once the fluid depth 116 has been determined, it may be employed to calculate the effective area. The effective area and the measured fluid velocity may be employed to calculate the flow rate (e.g., Q), via Q=V·A_{eff}

For embodiments that employ the enhanced version of the ME, values for the additive and magnitude parameter are chosen. The values for the additive and magnitude parameters may be a function of the measured velocity and/or depth. In various non-limiting embodiments, the values for the additive and magnitude parameters may be divided into three fluid velocity regimes. That is, a first set of values for the two parameters may be associated with a “low” fluid velocity regime, a second set of the values for the two parameters may be associated with a “medium” fluid velocity regime, and a third set of values may be associated with a “high” fluid velocity regime. More particularly, a first set of values for the two parameters may be employed if the measured velocity 118 is less than a first velocity threshold. A second set of values for the two parameters may be employed if the measured velocity 118 is less than a second velocity threshold but greater than the first velocity threshold, e.g., the second velocity threshold having a greater value than the first velocity threshold. A third set of values for the two parameters may be employed if the measured velocity 118 is greater than the second velocity threshold. In other embodiments, the discretization (of binning) of the values for the set of parameters may include greater than three bins. Any number of bins may be employed for modeling the values of the parameters as a function of fluid velocity. The values of the parameters, as function of fluid velocity may be determined from empirical experimentation and/or empirical observations. One non-limiting embodiment for empirically determining the values for the parameters is discussed in conjunction with at least FIG. 2C. In some embodiments, the value of the additive constant may be negative or positive, but is rarely greater than 1.0. The value of the magnitude constant may be positive, and is generally between 0.1 and 1.9.

In other embodiments, the sensor (e.g., fluid sensor 108) may be enabled to acquire sensor data that encodes the fluid depth 116. The velocity encoding sensor data may be provided to the flow rate calculator 106 via the communication network 110. Accordingly, either the first or second version of the ME and the measurement of the fluid depth 116 may be employed to estimate, calculate, and/or predict the fluid velocity 118, via the first or second versions of the ME. In some embodiments, the fluid velocity 118 may be calculated, via the first version of the ME and the measured fluid depth 116. The estimated value of the fluid velocity 118 may be employed to determine the appropriate values of magnitude and additive constants of the enhanced version of the ME. The estimated value for the fluid velocity 118 may be updated based on the measurement of the fluid depth 116, the enhanced version of the ME, and the determined values for the magnitude and additive constant. The measured fluid depth 116 may be employed to calculate the effective area. The effective area and the calculated (via the first or second ME) fluid velocity may be employed to calculate the flow rate (e.g., Q), via Q =V

The flow rate calculator 106 may be enabled to perform all calculations and/or manipulations of the sensor data and the first and second ME. That is, the flow rate calculator 106 may calculate the fluid depth 116, based on the measured fluid velocity 118. Likewise, the flow rate calculator 106 may calculate the fluid depth 116, based on the measured fluid velocity 118, based on the measured fluid depth 116. The flow rate calculator 106 may calculate the volumetric flow rate based on the measured/calculated fluid velocity 118 and the effective area. The flow rate calculator 106 may provide results in the form of a report and/or other indicator to a user of client device 102 and/or servicer device 104.

Communication network 110 may be a general or specific communication network. Communication network 110 may be any communication network, including virtually any wired and/or wireless communication technologies, wired and/or wireless communication protocols, and the like. Communication network 110 may be virtually any communication network that communicatively couples a plurality of computing devices and storage devices in such a way as to computing devices to exchange information via communication network 110. It should be noted that some embodiments do not rely on a communication network. That is, the fluid sensor data generated by fluid sensor 108 may be retrieved and/or acquired manually. For example, one may manually download (or “pull”) the fluid sensor data, at fluid sensor, via a USB stick, or some other data transfer means.

It should be understood that fluid flow system 100 shown in FIG. 1 is an example of one suitable operating system. Each of the components shown in FIG. 1 may be implemented via any type of computing device, such as computing device 3 described in connection to FIG. 3, for example. These components may communicate with each other via network 110, which may include, without limitation, a local area network (LAN) and/or a wide area networks (WAN). In exemplary implementations, communications network 110 comprises the Internet and/or a cellular network, amongst any of a variety of possible public and/or private networks. As noted above, some embodiments do not requires a communication network because the data may be pulled from the fluid sensor via manual means. Operating environment 100 can be utilized to implement any of the various embodiments described herein.

### Example Methods for Calibrating Fluid Flow Measurements in a Fluid Flow System

With reference to FIGS. 2A-2C, flow diagrams are provided illustrating methods for calibrating fluid flow measurements in a fluid flow system, such as but not limited to drainage system 100 of FIG. 1. The methods may be performed using any of the embodiments of a described herein. For example, a flow rate calculator (e.g., flow rate calculator 106 of FIG. 1) may implement at least a portion of the methods and/or actions discussed in the context of FIGS. 2A-2C. In embodiments, one or more computer storage media having computer-executable instructions embodied thereon that, when executed, by one or more processors can cause the one or more processors to perform the methods in the storage system.

Turning to FIG. 2A, a flow diagram is provided that illustrates a method 200 for determining a volumetric flow rate of fluid based on a measurement of the fluid's velocity in a fluid flow system that is consistent with the various embodiments. Such fluid flow systems include, but are not limited to fluid flow system 100 of FIGS. 1. Method 200 begins at block 202, where flow path parameters may be accessed. Various flow path parameters may include, but are not limited to flow path radius (e.g., flow path radius 114 of FIG. 1), the total cross-sectional area of the flow path (e.g., flow path 112 of FIG. 1), the perimeter and/or shape of the flow path, the Gauckler-Manning coefficient for the flow path (e.g., n in either the first or second versions of the ME), the slope of the hydraulic grade of the flow path (e.g., S in either the first or second version of the ME), and the like.

At block 204, a fluid velocity measurement is received. The measurement may include the measurement of a magnitude of the fluid velocity (e.g., fluid velocity 118 of FIG. 1). The measurement may be encoded in sensor data generated and/or acquired by a fluid sensor (e.g., fluid sensor 108 of FIG. 1). The data may be received at a flow rate calculator (e.g., flow rate calculator 106 of FIG. 1), and be received over a communication network (e.g., communication network 110 of FIG. 1). As noted above, a communication network is not required for all embodiments. For example, the fluid sensor data may be “pulled” from the fluid sensor at the location of the fluid sensor. At block 206, which is relevant to embodiments that employ the enhanced version of the ME, a value for an additive parameter may be determined based on the value for the magnitude of the fluid velocity. Additionally at block 206, a value for a magnitude parameter may be determined based on the value for the magnitude of the fluid velocity.

At block 208, the flow rate calculator may iteratively approximate (or estimate) a value of a fluid depth (e.g., fluid depth 116 of FIG. 1) based on the flow path parameters, the fluid velocity data, and either the first or second version of the ME. For embodiments that employ the enhanced (e.g., the second) version of the ME, the iterative determination of the fluid depth is further based on the determined values for the additive parameter and the value of the magnitude parameter. At block 210, the effective area (e.g., the wetted area) of the flowing fluid may be calculated based on the approximated value of the fluid depth and the flow path parameters. At block 212, the volumetric flow rate (e.g., Q) may be determined based on the fluid velocity data and the effective area of the flow path. In at least one, embodiment, the flow rate calculator may calculate the volumetric fluid flow rate via the relationship, Q=V·A_{eff}. The flow rate calculator may provide the calculated volumetric flow rate to a user of a computing device (e.g., client device 102 and/or server computing device 104 of FIG. 1).

Turning to FIG. 2B, a flow diagram is provided that illustrates a method 230 for determining a volumetric flow rate of fluid based on a measurement of the fluid's depth in a fluid flow system that is consistent with the various embodiments. Such fluid flow systems include, but are not limited to fluid flow system 100 of FIGS. 1. Method 220 begins at block 222, where flow path parameters may be accessed. Various flow path parameters may include, but are not limited to flow path radius (e.g., flow path radius 114 of FIG. 1), the total cross-sectional area of the flow path (e.g., flow path 112 of FIG. 1), the perimeter and/or shape of the flow path, the Gauckler-Manning coefficient for the flow path (e.g., n in either the first or second versions of the ME), the slope of the hydraulic grade of the flow path (e.g., S in either the first or second version of the ME), and the like.

At block 224, a fluid depth measurement is received. The measurement may include the measurement of a fluid depth in a flow path (e.g., fluid depth 116 of flow path 112 of FIG. 1). The measurement may be encoded in sensor data generated and/or acquired by a fluid sensor (e.g., fluid sensor 108 of FIG. 1). The data may be received at a flow rate calculator (e.g., flow rate calculator 106 of FIG. 1), and be received over a communication network (e.g., communication network 110 of FIG. 1). As noted above, a communication network is not required for all embodiments. For example, the fluid sensor data may be “pulled” from the fluid sensor at the location of the fluid sensor. At block 226, a magnitude of the fluid's velocity may be determined based on the flow path parameters, the fluid depth data, and the conventional ME. At block 228, which is relevant to embodiments that employ the enhanced version of the ME, a value for an additive parameter may be determined based on the value for the approximated magnitude of the fluid velocity. Additionally at block 228, a value for a magnitude parameter may be determined based on the value for the magnitude of the fluid velocity.

At block 230, the flow rate calculator may update the approximated (or estimated) a value of a fluid velocity (e.g., fluid velocity 118 of FIG. 1) based on the flow path parameters, the fluid depth data, and either the enhanced version of the ME. For embodiments that employ the enhanced (e.g., the second) version of the ME, the iterative update to the fluid velocity is further based on the determined values for the additive parameter and the value of the magnitude parameter. At block 232, the effective area (e.g., the wetted area) of the flowing fluid may be calculated based on the approximated value of the fluid depth (e.g., encoded in the fluid depth data) and the flow path parameters. At block 234, the volumetric flow rate (e.g., Q) may be determined based on the fluid velocity data and the effective area of the flow path. In at least one, embodiment, the flow rate calculator may calculate the volumetric fluid flow rate via the relationship, Q=V·A_{eff}. The flow rate calculator may provide the calculated volumetric flow rate to a user of a computing device (e.g., client device 102 and/or server computing device 104 of FIG. 1).

Turning to FIG. 2C, a flow diagram is provided that illustrates a method 240 for determining values for an additive parameter and a magnitude parameter, as a function of fluid velocity, based on a measurement of the fluid's velocity and a measurement of the fluid's depth in a fluid flow system that is consistent with the various embodiments. Such fluid flow systems include, but are not limited to fluid flow system 100 of FIGS. 1. For embodiments that employ the enhanced version of the ME, values for the additive and magnitude parameter are chosen. The values for the additive and magnitude parameters ay be a function of the measured velocity and/or depth. In various non-limiting embodiments, the values for the additive and magnitude parameters may be divided into three fluid velocity regimes. That is a first set of values for the two parameters may be associated with a “low” fluid velocity regime, a second set of the values for the two parameters may be associated with a “medium” fluid velocity regime, and a third set of values may be associated with a “high” fluid velocity regime. More particularly, a first set of values for the two parameters may be employed if the measured velocity 118 is less than a first velocity threshold, A second set of values for the two parameters may be employed if the measured velocity 118 is less than a second velocity threshold but greater than the first velocity threshold, e.g., the second velocity threshold having a greater value than the first velocity threshold. A third set of values for the two parameters may be employed if the measured velocity 118 is greater than the second city threshold. In other embodiments, the discretization (of binning) of the values for the set of parameters may include greater than three bins. Any number of bins may be employed for modeling the values of the parameters as a function of fluid velocity. The values of the parameters, as function of fluid velocity may be determined from empirical experimentation and/or empirical observations. In some embodiments, the value of the additive constant may be negative or positive, but is rarely greater than 1.0. The value of the magnitude constant ay be positive and is generally between 0.1 and 1.9.

Method 240 begins at block 242, where flow path parameters may be accessed. Various flow path parameters may include, but are not limited to flow path radius (e.g., flow path radius 114 of FIG. 1), the total cross-sectional area of the flow path (e.g., flow path 112 of FIG. 1), the perimeter and/or shape of the flow path, the Gauckler-Manning coefficient for the flow path (e.g., n in either the first or second versions of the ME), the slope of the hydraulic grade of the flow path (e.g., S in either the first or second version of the ME), and the like.

At block 244, a fluid velocity measurement and a fluid depth measurement is received. The fluid velocity measurement may include the measurement of a magnitude of the fluid velocity (e.g., fluid velocity 118 of FIG. 1). The fluid depth measurement may include the measurement of a fluid depth in a flow path (e.g., fluid depth 116 of flow path 112 of FIG. 1). The measurement may be encoded in sensor data generated and/or acquired by a fluid sensor (e.g., fluid sensor 108 of FIG. 1). The fluid data may be generated by the same fluid sensor (e.g., a fluid sensor that is enabled to measure both the fluid velocity and the fluid depth). In other embodiments, the fluid data may be generated by separate fluid sensors (e.g., a first sensor that is enabled to measure the fluid velocity and a second fluid sensor that is enabled to measure the fluid's depth. Whether generated by a single fluid sensor, or multiple fluid sensors, the data may be received at a flow rate calculator (e.g., flow rate calculator 106 of FIG. 1), and be received over a communication network (e.g., communication network 110 of FIG. 1). As noted above, a communication network is not required for all embodiments. For example, the fluid sensor data may be “pulled” from the fluid sensor at the location of the fluid sensor.

At block 246, the effective area (e.g., the wetted area) of the flowing fluid may be calculated based on the measured value of the fluid depth and the flow path parameters. At block 248, the wetted parameter of the flow path is calculated based on the fluid depth data and the flow path parameters. At block 250, the hydraulic radius of the flow path may be calculated based on the effective area and the wetted parameter of the flow path. At block 252, the additive parameter and the magnitude parameter for the measured fluid velocity may be determined. In various embodiments, calculating the two parameters may be based on the fluid velocity data, the fluid depth data, and the hydraulic radius of the flow path. In various embodiments, the enhanced version of the ME equation may be employed to iteratively determine the value of the two parameters. As noted above, in various embodiments, the values for the two parameters may be determined for at least three fluid velocity regimes.

### Generalized Computing Device

With reference to FIG. 3, computing device 300 includes a bus 310 that directly or indirectly couples the following devices: memory 312, one or more processors 314, one or more presentation components 316, one or more input/output (I/O) ports 318, one or more I/O components 320, and an illustrative power supply 322. Bus 310 represents what may be one or more busses (such as an address bus, data bus, or combination thereof). Although the various blocks of FIG. 3 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 3 is merely illustrative of an exemplary computing device that can be used in connection with one or more embodiments of the present disclosure. Distinction is not made between such categories as “workstation,” “server,” “laptop,” “handheld device,” etc., as all are contemplated within the scope of FIG. 3 and with reference to “computing device.”

Computing device 300 typically includes a variety of computer-readable media. Computer-readable media can be any available media that can be accessed by computing device 300 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 300. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 312 includes computer storage media in the form of volatile and/or nonvolatile memory. The memory may be removable, non-removable, or a combination thereof. Exemplary hardware devices include solid-state memory, hard drives, optical-disc drives, etc. Computing device 300 includes one or more processors 314 that read data from various entities such as memory 312 or I/O components 320. Presentation component(s) 316 presents data indications to a user or other device. In some implementations, presentation component 220 of system 200 may be embodied as a presentation component 316. Other examples of presentation components may include a display device, speaker, printing component, vibrating component, and the like.

The I/O ports 318 allow computing device 300 to be logically coupled to other devices, including I/O components 320, some of which may be built in. Illustrative components include a microphone, joystick, game pad, satellite dish, scanner, printer, wireless device, etc. The I/O components 320 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 300. The computing device 300 may be equipped with depth cameras, such as stereoscopic camera systems, infrared camera systems, RGB camera systems, and combinations of these, for gesture detection and recognition. Additionally, the computing device 300 may be equipped with accelerometers or gyroscopes that enable detection of motion. The output of the accelerometers or gyroscopes may be provided to the display of the computing device 300 to render immersive augmented reality or virtual reality.

Some embodiments of computing device 300 may include one or more radio(s) 324 (or similar wireless communication components). The radio 324 transmits and receives radio or wireless communications. The computing device 300 may be a wireless terminal adapted to receive communications and media over various wireless networks. Computing device 300 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include, by way of example and not limitation, a Wi-Fi® connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

Many different arrangements of the various components depicted, as well as components not shown, are possible without departing from the scope of the claims below. Embodiments of the disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

With reference to the technical solution environment described herein, embodiments described herein support the technical solution described herein. The components of the technical solution environment can be integrated components that include a hardware architecture and a software framework that support constraint computing and/or constraint querying functionality within a technical solution system. The hardware architecture refers to physical components and interrelationships thereof, and the software framework refers to software providing functionality that can be implemented with hardware embodied on a device.

The end-to-end software-based system can operate within the system components to operate computer hardware to provide system functionality. At a low level, hardware processors execute instructions selected from a machine language (also referred to as machine code or native) instruction set for a given processor. The processor recognizes the native instructions and performs corresponding low level functions relating, for example, to logic, control and memory operations. Low level software written in machine code can provide more complex functionality to higher levels of software. As used herein, computer-executable instructions includes any software, including low level software written in machine code, higher level software such as application software and any combination thereof. In this regard, the system components can manage resources and provide services for system functionality. Any other variations and combinations thereof are contemplated with embodiments of the present disclosure.

By way of example, the technical solution system can include an Application Programming Interface (API) library that includes specifications for routines, data structures, object classes, and variables may support the interaction between the hardware architecture of the device and the software framework of the technical solution system. These APIs include configuration specifications for the technical solution system such that the different components therein can communicate with each other in the technical solution system, as described herein.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present disclosure are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present disclosure may generally refer to the technical solution environment and the schematics described herein, it is understood that the techniques described may be extended to other implementation contexts.

Embodiments of the present disclosure have been described in relation to particular embodiments which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computer-implemented method for managing water in a fluid flow system, the method comprising:
receiving fluid velocity data that encodes a magnitude of a velocity for a fluid that is flowing in a flow path;
approximating a depth of the fluid in the flow path based on a fluid-flow model, a set of flow path parameters, and the magnitude of the velocity, wherein the set of flow path parameters characterizes one or more properties of the flow path;
calculating an effective area of the flow path based on the depth of the fluid flowing in the flow path and the set of flow path parameters; and
determining a flow rate of the fluid flowing in the flow path based on the magnitude of the velocity of the fluid flowing in the flow path.

2. The method of claim 1, wherein the fluid-flow model is a version of a Manning's equation (ME), and the method further comprises:
determining values for a set of parameters based on the fluid velocity data, wherein the values for the set parameters are associated with the version of the ME; and
iteratively approximating the depth of the fluid in the flow path based on the determined values for the set of parameters.

3. The method of claim 2, wherein the set parameters includes a first parameter that is added to a roughness coefficient of the version of the ME and a second parameter that acts as an exponent in the version of the ME.

4. The method of claim 1, further comprising:
providing an indication of the flow rate of the fluid to a user.

5. The method of claim 1, wherein the fluid velocity data was acquired by and transmitted from, via a communication network, a fluid sensor installed within the flow path.

6. The method of claim 1, wherein the set of flow path parameters includes at least a roughness coefficient that characterizes a roughness of the flow path, a radius of the flow path, and a slope of a hydraulic grade of the flow path.

7. The method of claim 1, further comprising:
determining a wetted perimeter based on a radius of the flow path and the depth of the fluid;
determining a hydraulic radius of the flow path based on the effective area of the flow path and the wetted perimeter of the flow path; and
determining the flow rate of the fluid based on the hydraulic radius of the flow path.

8. A system comprising:
one or more hardware processors; and
one or more computer-readable media having executable instructions embodied thereon, which, when executed by the one or more processors, cause the one or more hardware processors to execute actions method for managing water in a fluid flow system, the actions comprising:
receiving fluid velocity data that encodes a magnitude of a velocity for a fluid that is flowing in a flow path;
approximating a depth of the fluid in the flow path based on a fluid-flow model, a set of flow path parameters, and the magnitude of the velocity, wherein the set of flow path parameters characterizes one or more properties of the flow path;
calculating an effective area of the flow path based on the depth of the fluid flowing in the flow path and the set of flow path parameters; and
determining a flow rate of the fluid flowing in the flow path based on the magnitude of the velocity of the fluid flowing in the flow path.

9. The system of claim 8, wherein the fluid-flow model is a version of a Manning's equation (ME), and the actions further comprise:
determining values for a set of parameters based on the fluid velocity data, wherein the values for the set parameters are associated with the version of the ME; and
iteratively approximating the depth of the fluid in the flow path based on the determined values for the set of parameters.

10. The system of claim 9, wherein the set parameters includes a first parameter that is added to a roughness coefficient of the version of the ME and a second parameter that acts as an exponent in the version of the ME.

11. The system of claim 8, wherein the actions further comprise:
providing an indication of the flow rate of the fluid to a user.

12. The system of claim 8, wherein the fluid velocity data was acquired by and transmitted from, via a communication network, a fluid sensor installed within the flow path.

13. The system of claim 8, wherein the set of flow path parameters includes at least a roughness coefficient that characterizes a roughness of the flow path, a radius of the flow path, and a slope of a hydraulic grade of the flow path.

14. The system of claim 8, wherein the actions further comprise:
determining a wetted perimeter based on a radius of the flow path and the depth of the fluid;
determining a hydraulic radius of the flow path based on the effective area of the flow path and the wetted perimeter of the flow path; and
determining the flow rate of the fluid based on the hydraulic radius of the flow path.

15. One or more computer storage media storing computer-useable instructions that, when used by one or more computing devices, cause the one or more computing devices to perform actions for managing water in a fluid flow system, the actions comprising:
receiving fluid sensor data that encodes a magnitude of a velocity and a fluid depth for a fluid that is flowing in a flow path of the fluid flow system;
calculating a hydraulic radius for the flow path based on the fluid depth and a set of flow path parameters that characterizes one or more properties of the flow path; and
calculating values for a set of parameters for a fluid-flow model based on the magnitude of the velocity, the fluid depth, and the hydraulic radius of the flow path.

16. The one or more computer storage media of claim 15, wherein the fluid-flow model is a version of a Manning's equation (ME) and the set parameters includes a first parameter that is added to a roughness coefficient of the version of the ME and a second parameter that acts as an exponent in the version of the ME.

17. The one or more computer storage media of claim 15, wherein the actions further comprise:
calculating the values for the set of parameters for at least three separate fluid velocity regimes.

18. The one or more computer storage media of claim 15, wherein the fluid sensor data was acquired by and transmitted from, via a communication network, a fluid sensor installed within the flow path.

19. The one or more computer storage media of claim 15, wherein the set of flow path parameters includes at least a roughness coefficient that characterizes a roughness of the flow path, a radius of the flow path, and a slope of a hydraulic grade of the flow path.

20. The one or more computer storage media of claim 15, the actions further comprising:
determining a wetted perimeter of the flow path based on a radius of the flow path and the depth of the fluid;
determining an effective area of the flow path based on the radius of the flow path and the depth of the fluid; and
calculating the hydraulic radius for the flow path based on the wetted parameter and the effective area of the flow path.
